(19) United States
(12) Patent Application Publication
(10) Pub. No.: US 2024/0416656 A1
(43) Pub. Date: Dec. 19, 2024

(54) METHOD FOR MAINTENANCE OF A PRINT HEAD OF AN INKJET PRINTER

(71) Applicant: Canon Production Printing Holding B.V., Venlo (NL)

(72) Inventors: Carolus A.M. KNECHTEN, Venlo (NL); Gor MANUKYAN, Venlo (NL)

(73) Assignee: Canon Production Printing Holding B.V., Venlo (NL)

(21) Appl. No.: 18/679,258

(22) Filed: May 30, 2024

(30) Foreign Application Priority Data
Jun. 13, 2023 (EP) 23178975.1

(51) Int. Cl. B41J 2/165

(52) U.S. Cl. CPC B41J 2/16526; B41J 2/16552; B41J 2002/16555

(57) ABSTRACT

A method for maintenance of a print head of an inkjet printer, the print head comprising a nozzle surface (or plate) with a plurality of ink nozzles for jetting ink, wherein the method comprises the steps of purging the plurality of ink nozzles at least once, and performing a contact wipe over the nozzle surface (or plate) with a contact pressure such that the contact wipe barely touches the nozzle surface (or plate), with a wet tissue comprising a wetting liquid, with vacuum pressure provided by an air pressure support unit. The invention also relates to an inkjet printer configured to execute the method.

The present invention relates to a method for maintenance of at least one print head of an inkjet printer, the at least one print head comprising an inlet to an ink chamber leading to a plurality of ink nozzles positioned in a nozzle surface and suitable for jetting ink, the inkjet printer comprising at least one air pressure supply unit, wherein the method comprises the step of
purging the plurality of ink nozzles at least once by putting a positive air pressure on the ink chamber by means of the at least one air pressure supply unit.

Marking material is meant to be an ink, for example an UV curable ink.

Image receiving medium is meant to be paper, plastic, metal, wood, transparent material, glass, cardboard, label stock, coated paper, textile or any other printable medium.

With a positive air pressure is meant an air pressure which is above ambient pressure. With a vacuum air pressure is meant an air pressure which is below ambient pressure. Hereinafter an amount of a particular air pressure is given as a difference between the particular air pressure and the ambient pressure. In other words, the air pressure is expressed as an air pressure relative to the ambient pressure.

A contact pressure may also be referred to as a mechanical pressure.

### BACKGROUND OF THE INVENTION

During printing the nozzle surface (or plate) may become clogged with ink residue which has to be removed in order to keep the plurality of nozzles in a good condition. The nozzle surface may contain the endings of nozzles. The ink residue may contain pigment particles. Therefore the nozzle surface (or plate) is maintained in a good health by tissue wiping. By good health is meant to prevent print artifacts such as side shooters, jet angle errors, clogging nozzles, etc. A tissue—woven or non-woven—is comprised in a cassette. The cassette may be replaced regularly, may be recyclable or may be disposable. The tissue contact the nozzle surface and also the environment of the nozzles. Spitting in the tissue is allowed by spanning the tissue horizontally below the at least one print head. Instead of only replacing the tissue the full cassette can be a consumable and replaced by the customer, to achieve a hassle free concept with safe handling of ink. The cassette can be disposed of as a whole, or recycled by replacing the used tissue by a fresh tissue (asset recovery). Spitting may be executed on several locations like above a waste tray, in the image itself e.g. by means of a blue noise bitmap.

The printer comprises:
a tissue wipe maintenance unit;
at least one air pressure supply unit which supplies the at least one print head from the right vacuum pressures to air pressures above ambient conditions;
a purge tray unit which is a gutter to collect purge liquids from the at least one print head and transport the purge liquids to the liquid waste unit and also functions as print head leakage bin in case of calamity;
a liquid waste unit which is a waste bin in a drawer to collect waste liquid from the at least one print head directly or via the purge tray unit; and
a controller that is configured to control a print head maintenance method to lower the print head temperature for slowing down sedimentation and ink degradation.

The tissue wipe maintenance unit comprises:
a clean tray unit which holds the cassette and realizes correct cassette positioning and movements of the cassette;
measuring device; and
drives for moving the tissue and a means for keeping a tension in the tissue.

The basis of the print head maintenance tissue wiper is to keep the nozzle surface (or plate) free from ink residues. The at least one print head may count a plurality of nozzles with a diameter of approximately 22.5 to 30 μm and may generate a droplet volume of approximately 6 to 10 picoliter. Within the tissue wipe concept different process flows have been defined to ensure a clean and dry nozzle surface (or plate).

These process flows are initiated by maintenance strategies. Inline or off-line print quality measurements are used as input parameters within maintenance strategies.

The following maintenance actions are known:
1. Purge: this action is performed to ‘flush’ the nozzles. During a purge ink is dripping out of the nozzles, down in the purge tray unit. Therefore the purge tray unit is positioned below the at least one print head. Purging means that an external air pressure is applied to the print head upstream, such that ink is forced out of the nozzles. From the purge tray unit the ink flows into a waste liquid unit which collects all waste ink.
2. Wipe: After a purge action the nozzle surface (or plate) and FFP are wiped with a tissue, resulting in a dry and clean nozzle surface (or plate). While moving the cassette over the nozzle surface (or plate) the tissue is winded to refresh the tissue continuously. Ink is absorbed by the tissue and is disposed via the tissue. During a wipe the tissue is in contact with the nozzle surface (or plate) with a defined mechanical pressure.
3. Spit (during printing modus and stand-by modus): this action includes jetting of ink and is performed to keep the nozzle surface (or plate) dry and keep nozzles in right condition in standby and during printing. Spitting can be performed in a (heated) purge tray unit.
4. Standby: in standby mode the at least one print head can be positioned above the purge tray unit. In this way leakages can be collected without contaminating the engine.

An antiwetting coating may be applied to the at least one print head which is a known methodology to improve jet stability and cleanliness of the nozzle surface (or plate) in time. After a certain print time period the nozzle surface (or plate) will get dirty resulting in decreasing jet stability. An effective methodology to clean the at least one print head is by use of a tissue wipe. However, the abrasiveness of the tissue wipe process towards the antiwetting coating may result in a deterioration of antiwetting behavior of the at least one print head. The most relevant contributor to the wear of the antiwetting coating are pigment particles between the tissue and the at least one print head. A solution needs to be found to allow an effective cleaning of the print head nozzle surface (or plate).

It has been confirmed that the main failure mechanism is abrasion by pigments present in the wiping nip (i.e.; contact between the tissue and the nozzle surface), probably accompanied by a small chemical reaction component.

If present, the anti-wetting coating may deteriorate quickly by abrasion by the pigment in the nip of the roller with the nozzle surface (or plate) when no countermeasures are taken. Pigment particles in the nozzle can either come from ink on the nozzle surface (or plate) (purged ink and satellite/mist contamination) or from the nozzles (sucked out by the tissue). Pigment particles are present all over the ink. Also the ink on the nozzle surface contains pigment particles which is already a potential problem to solve. By drying in of ink on the nozzle surface or in the nozzles a risk for a larger concentration of pigment particles in the nip is larger and therefore also a risk for damage. With sufficient contact pressure on the roller, ink on the nozzle surface (or plate) can be prevented from entering the nip. Hence, the damaging pigment mainly originates from the nozzles, thought to be drawn out by a suction mechanism of the tissue.

All methods available so far are not sufficient for an adequate print head cleaning without damaging the nozzle surface (or plate) by pigment particles of the ink.

It is therefore an object of the present invention to provide a method which performs an adequate print head cleaning.

It is another object of the present invention to provide an ink jet printer suitable for performing such a method.

### SUMMARY OF THE INVENTION

The object is achieved in a method according to the invention, wherein the method comprises a purging step as described here-above and further comprises the step of performing a first wipe over the nozzle surface with a first contact pressure of close to 0 kPa such that the first wipe barely touches the nozzle surface, with the wet tissue comprising a wetting liquid and with a vacuum pressure provided by the at least one air pressure supply unit.

The first wipe over the nozzle surface is performed with the first contact pressure of close to 0 kPa, preferably at most 0.5 kPa.

Hereinafter the first wipe may also be referred to as the soft wipe.

The soft wipe performs two actions: it removes easily removable ink from the nozzle surface (or plate), and it pushes wetting liquid into the nozzles. The soft wipe removes all easily removable ink (including pigment particles) that can be removed with low force. Because low force is used, the risk of damaging the nozzle surface by the soft wipe is deemed low. If an antiwetting coating is provided on the nozzle surface (or plate), the soft wipe will mitigate the damage to the nozzle surface and the antiwetting coating which prolongs the lifetime of the at least one print head.

According to an embodiment the method comprises the step of d) spitting out the wetting liquid residing in the plurality of ink nozzles after the second wipe before commencing printing. Spitting means that the print head issues an actuation pulse that forces the wetting liquid in the ink nozzle to be spit out. Spitting is the act of jetting inkjet drops not for printing an image but as a part of getting or maintaining the nozzles in a good operational condition, e.g. removal of contaminations/refreshing the ink in the nozzles and removal of wetting liquid which has been sucked into the nozzles. Spitting can be performed during printing, for example at the position where the carriage with print heads reverses direction or in the print in positions where the spitted drops are not visible. In the present invention, spitting is executed after the wipes because wetting liquid is sucked into the nozzles, otherwise the first drops in the print will have a deviating color or no color at all. Spitting is the same as jetting, although slightly different settings (e.g. a different waveform of the actuation pulse) may be used to get optimal performance, for example larger drops without satellites which could contaminate the environment.

According to an embodiment the method comprises the step of c) performing a second wipe after the first wipe, the second wipe with the wet tissue comprising a wetting liquid, with a second contact pressure being higher than the first contact pressure in a range from 40 to 100 kPa and with vacuum pressure provided by means of the at least one air pressure supply unit. The purpose of the second wipe is to remove most of the remaining, preferably all ink from the nozzle surface during the second wipe. After the second wipe the nozzle surface is almost dry. Hereinafter the second wipe may also be referred to as the hard wipe.

According to an embodiment the step of performing the first wipe comprises the step of positioning the wet tissue near the nozzle surface (or plate) so that it barely touches the nozzle surface (or plate).

The step of performing the first wipe may comprise the step of pushing side rollers against bars of the nozzle surface (or plate). The side rollers may be guidance rollers which take care of a fixed distance between the wipe roller and the nozzle surface.

The step of performing the second wipe may comprise the step of applying the second contact pressure by means of springs which load bias a roller which presses the tissue to the nozzle surface (or plate) in order to ensure a constant contact pressure.

The step of performing the first wipe comprises a removal of easily removable ink residue including pigment particles residing on the nozzle surface and in the plurality of ink nozzles and a push of the wetting liquid into the plurality of nozzles. The first wipe takes care that the second wipe does not damage the nozzle surface or at least mitigates the damage to the nozzle surface.

The step of performing the second wipe comprises a removal of wetting liquid from the plurality of nozzle surface during the second wipe. The second wipe takes care of the real cleaning of the nozzle surface, also the more stuck ink. After the second wipe there is still wetting liquid in the nozzles.

The method according to the present invention comprises at least one step related to a provision of air pressure which is provided by the at least one air pressure support unit. For all those steps only one air pressure support unit maybe implemented in the printer according to the present invention. However, in case more than one air pressure support units are implemented in the printer according to the present invention, different steps related to the provision of air pressure may be provided by different air pressure support units of the printer.

The present invention further relates to a digital inkjet printer for printing images on an image receiving medium on a printing surface, the digital inkjet printer comprising a print controller, at least one print head with a nozzle surface (or plate) with ink nozzles for ejecting marking material on the image receiving medium, a wiper for cleaning the nozzle surface (or plate) with the ink nozzles and a maintenance tray for receiving marking material spit from at least part of the ink nozzles, wherein the print controller is configured to control the steps of the method according to the invention.

The present invention further relates to a software product comprising program code on a machine-readable medium, which program code, when loaded into a print controller of a digital inkjet printer for printing images on an image receiving medium on a printing surface and having at least one print head, causes the print controller to control the at least one print head in accordance with a method according to the invention, wherein the at least one print head comprises a nozzle surface (or plate) with ink nozzles for ejecting marking material on the image receiving medium, a wiper for cleaning the nozzle surface (or plate) with the ink nozzles and a maintenance tray for receiving marking material spit from at least part of the ink nozzles.

### BRIEF DESCRIPTION OF THE DRAWINGS

These and further features and advantages of the present invention are explained hereinafter with reference to the accompanying drawings showing non-limiting embodiments and wherein:

FIG. 1 shows a schematic representation of a part of an inkjet printing system according to the present invention,

FIG. 2(a) shows a schematic exploded representation of a maintenance unit according to the present invention,

FIG. 2(b) shows a schematic representation of a cassette according to the present invention,

FIG. 3(a)-3(d) schematically visualize the steps of embodiments of the method according to the present invention,

FIG. 4 shows an implementation of the first wipe according to the present invention,

FIG. 5 shows an implementation of the second wipe according to the present invention,

FIG. 6(a)-6(d) are flow diagrams of embodiments of the method according to the present invention.

In the drawings, same reference numerals refer to same elements.

### DETAILED DESCRIPTION OF THE DRAWINGS

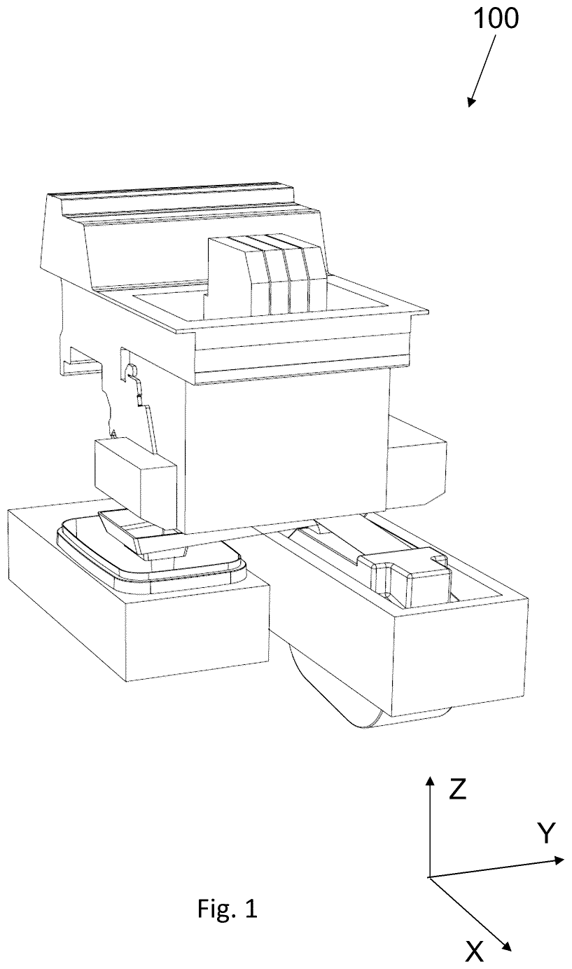

FIG. 1 shows an ink jet printer 100 comprising the at least one print head and the maintenance tissue wipe unit which is located on one side of the ink jet printer. The at least one print head is positioned above the tissue by moving the carriage in an Y-direction as shown in FIG. 1. Consequently the cassette is moved into the right position below the printhead via X and Z movements as shown in FIG. 1.

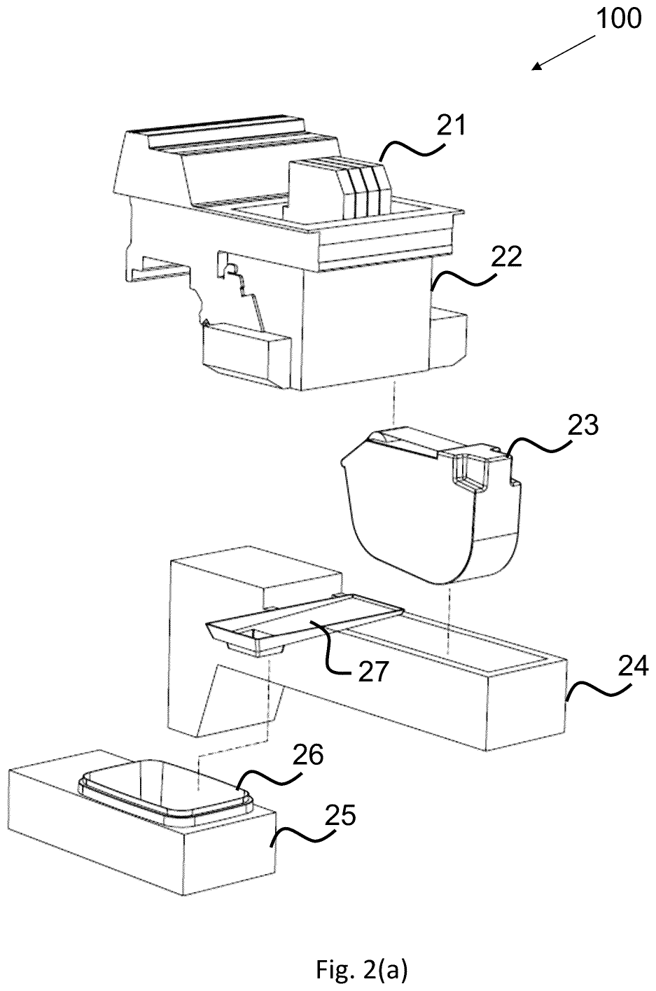

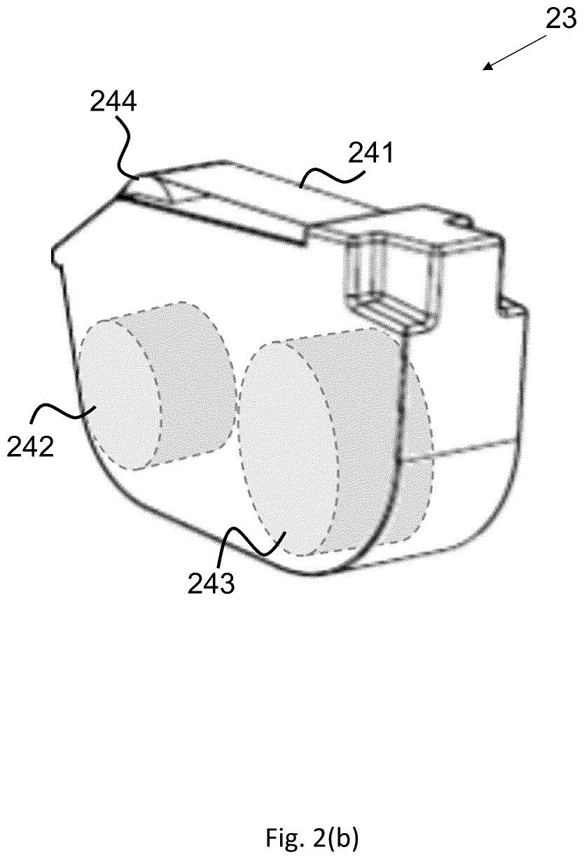

FIG. 2(a) shows FIG. 1 in an exploded way. The at least one print head 21 is mounted on the carriage 22 and is configured to eject ink to the print surface (not shown). The maintenance unit comprises a cassette 23 being a disposable module containing a fresh tissue roll and a used tissue roll, a purge tray unit 27 being a gutter to collect purge liquids and ink leakages from the at least one print head and transport them to the liquid waste unit, and a clean tray unit 24 which holds the cassette and realizes correct cassette positioning and movements. Next to the maintenance tissue wipe unit the liquid waste unit 25, 26 is located which collects the waste liquid and includes a waste bin 26 and leakage tray 25. The maintenance tray 24 is providing movement of the cartridge 23.

FIG. 2(b) shows an embodiment of the cartridge 23 in more details. The cartridge is provided with a first cassette 242 holding a fresh roll and a second cassette 243 holding a dirty roll. The tissue 241 can be transported from the fresh roll contained in the cassette 242 and wound up on the dirty roll contained in the cassette 243. A soft nip roller 244 presses the tissue 241 against the nozzle plate (not shown) holding ink residue.

A purge wipe may be performed on more than one print head 21 (See FIG. 2(a)) simultaneously. In case of multiple print heads with colors Cyan, Yellow, Magenta, Black and White (CYMKW), more than one purge wipe cycles may be performed to maintain all print heads. The same applies to spitting in the tissue 241. The number of print heads which can be wiped simultaneously is directly related to the width of the tissue 241.

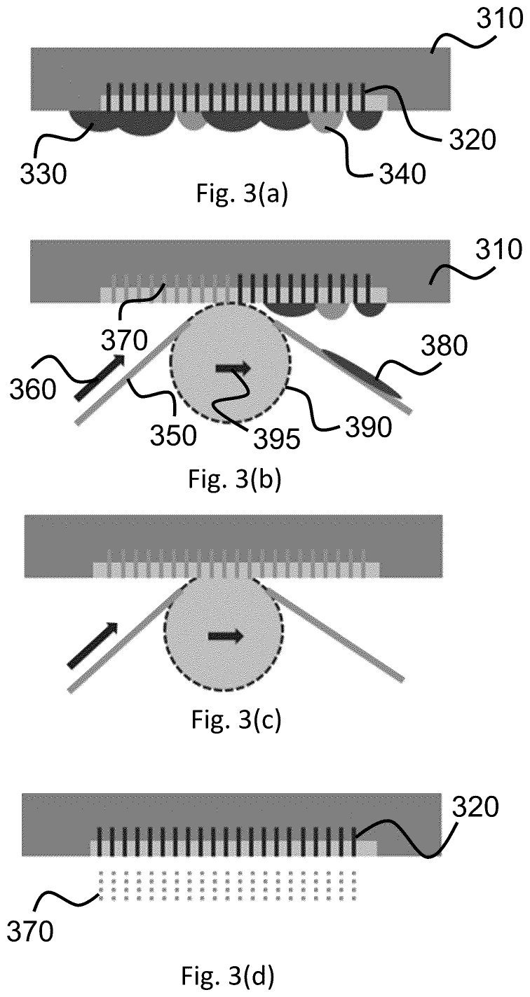

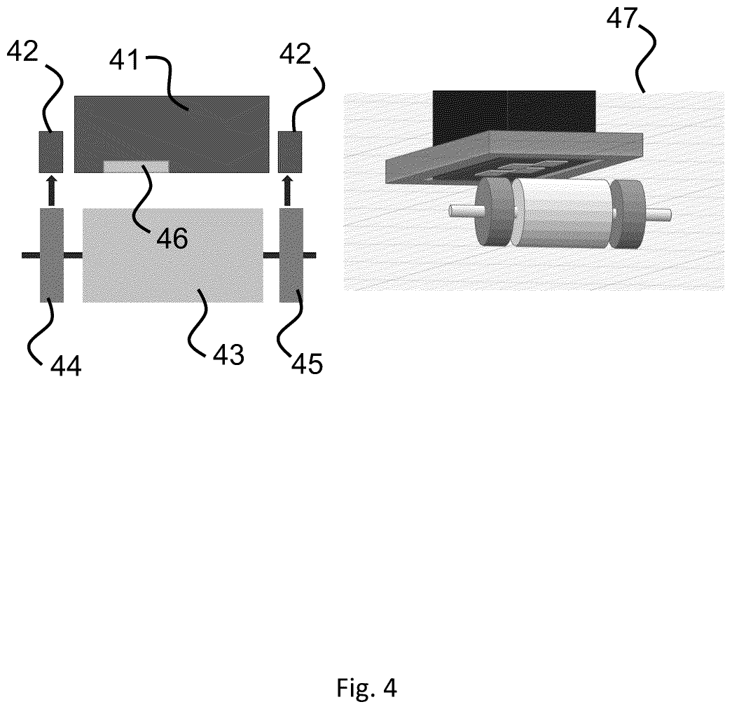

FIG. 3(a) visualizes the first step a) of the method according to the invention, wherein the plurality of ink nozzles 320 located in the nozzle surface (or plate) 310 are purged at least once.

An ink purge is preventively needed to refresh ink 330 in the nozzle channels (prevent ink sedimentation and evaporation), and correctively needed to remove air or “debris” out of the nozzle channels (recover failing nozzles). The ink properties are determining the purge strategy, for example the purge volume. Ink residue 330 and wetting liquid residue 340—if any—are purged out of the nozzles 320.

An ink purge is generated by the air pressure supply unit (not shown) and will be collected in the waste bin via the purge tray unit 27. Purging in the tissue is not preferred as this limits the purge volume and due to ink migration throughout the tissue we have to feed forward the tissue each purge/wipe to create fresh tissue to wipe with, the latter consumes unwanted tissue. Before the first wipe a pressure pulse is performed by the air pressure supply unit to create the ink purge.

After the purge ink 330 is remaining on the lower surface of the nozzle surface (or plate) 320. To continue printing the nozzle surface (or plate) 320 needs to be dry and clean. To achieve this target the nozzle surface (or plate) needs to be wiped.

The pressure pulse for purging may be for example in a range of 200 to 400 mbar during a range of 200 to 2000 milliseconds. Such a pressure pulse pushes out ink as well as the wetting liquid from a previous wipe.

FIG. 3(b) visualizes the second step b) of the method according to the invention, wherein a first wipe is performed over the nozzle surface (or plate) 310 with a first contact pressure such that the first wipe barely touches the nozzle surface (or plate) 310. The first contact pressure is preferably less than 1 kPa. The first wipe is performed with a wet tissue 350 comprising a wetting liquid 370, and with a vacuum pressure provided by the air pressure supply unit. The wetting liquid is compatible (mixable) with ink and print head, and should be jettable. In other words, the wetting liquid has about the same viscosity and surface tension as the ink. The wet tissue 350 is transported via a roller 390 which moves in a direction 395 along the nozzle surface (or plate) 310. The wet tissue 350 is rolling accordingly in a direction 360. The nozzles which are wiped contain only the wetting liquid 370. The nozzles which have not been wiped still contain ink residue. The part of the nozzle surface (or plate) which has been wiped (in FIG. 3(b) the part of the nozzle surface (or plate) on the left side of the roller 390) is free from ink residue. The nozzle surface (or plate) which has not been wiped (in FIG. 3(b) the part of the nozzle surface (or plate) on the right side of the roller 390) still contains the ink residue due to the purge action visualized in FIG. 3(a).

The part of the tissue 350 on the left side of the roller 390 contains the wetting liquid 370. Ink residue is removed from the lower surface of the nozzle surface (or plate) 310 and adheres to the tissue 350. The part of the tissue 350 on the right side of the roller 390 contains the ink residue 380.

The vacuum pressure during the first wipe is approximately 30 mbar and is used to prevent ink leakage from the nozzles 320 but mainly to soak the wetting liquid 370 in the nozzles 320.

The tissue speed is held constant at approximately 30 mm/s and the wipe speed is approximately 20 mm/s. The wetting liquid 370 is pumped into the tissue via a wetting tube (not shown) at a predefined pumping speed which makes the tissue “fairly wet”, with the roller 390 easily shining through. The roller 390 may be a 32 mm toothed roller with a hardness of approximately 45 ShA.

FIG. 3(c) visualizes the step of c) performing a second wipe after the first wipe a second wipe with the wet tissue comprising a wetting liquid, with a second contact pressure being higher than the first contact pressure in a range from 40 to 100 kPa, with vacuum pressure between the wet tissue and the ink nozzles.

The vacuum pressure during the second wipe is approximately 8 mbar and is used to prevent ink leakage from the nozzles 320 and also to soak the wetting liquid 370 in the nozzles 320.

During the first wipe and the second wipe the vacuum pressure may be the same and may typically be higher than during printing. During printing the vacuum pressure is typically 10 mbar.

The second contact pressure may be applied by means of springs in order to ensure a constant contact pressure. For example, the second wipe may be applied by two springs with 8.5 N, at an impression of the roller 390 of 2.0 mm. The springs are already at a pre-tension in order to ensure a constant contact force and to be less sensitive to the impression.

FIG. 3(d) visualizes the step of d) spitting out the wetting liquid 370 residing in the plurality of ink nozzles 320 after the second wipe before commencing printing.

In case the nozzles 320 are not continuously used the state of the nozzles are worsening over time due to ink evaporation. Periodically spitting has been developed to overcome this problem. By frequently spitting a number of drops in standby we keep the ink in the nozzle 320 fresh and ready to print. The number of spit drops can be fixed or preferred, be determined based on measuring the ink viscosity in the nozzle. The spitting is enabled by actuation, e.g. by applying an electric pulse to a piezo- or thermo-electric print head mechanism. By spitting out the wetting liquid 370 the nozzles 320 are again filled with fresh ink before printing starts.

Spitting in standby is for all printheads which need to be ready to print. Spitting is performed in a dedicated area. To limit engine pollution print head spit settings need to be optimized to reduce mist as much as possible. In order to prevent mist distribution over the engine a distance between the print head and spitting surface is minimized.

FIG. 4 shows an implementation of the first wipe according to FIG. 3(b). A soft nip roller 43, over which the tissue runs, is mounted with two rollers 44, 45 on the side.

The rollers 44, 45 make contact with the bars 42 (matrix plate in which the print head 41 is mounted with high accuracy) on the side, resulting in a consistent position, chosen such that the tissue/nip roller 43 barely touches the surface of the chips 46. Image 47 gives a 3D impression of the implementation.

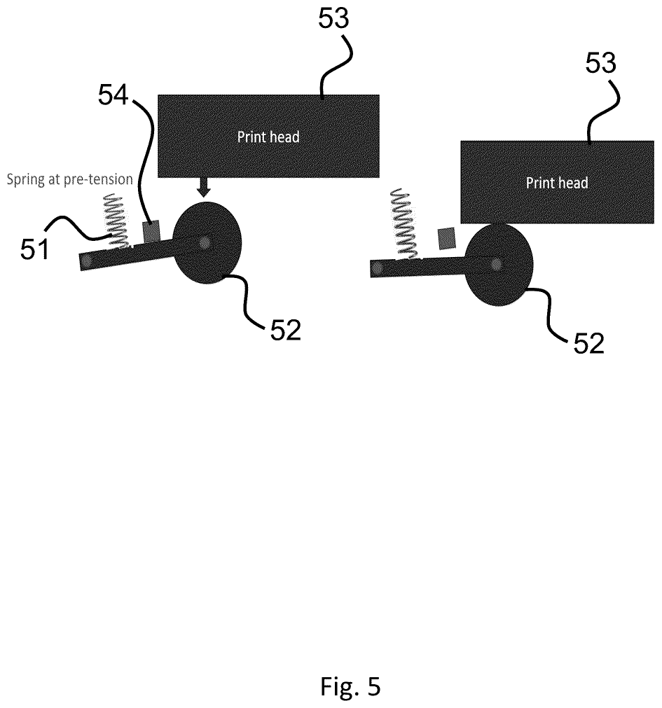

FIG. 5 shows an implementation of the second wipe according to FIG. 3(c). The second wipe is done by using springs 51 (with pre-tension) to press a roller 52 against the bottom of the print head 53. Using springs 51 with pre-tension guarantees that a related force is more or less independent from the accuracy of positioning. The spring 51 is put at a pre-tension by letting the arm rest against a block 54.

An implementation of both the first and the second wipe in one system could be to put the two rollers 43 (FIG. 4) and 52 (FIG. 5) after each other, such that only one wipe pass is necessary. Firstly the first wipe is done with the side rollers 44, 45 engaged, and secondly the second wipe is done with the side rollers 44, 45 disengaged.

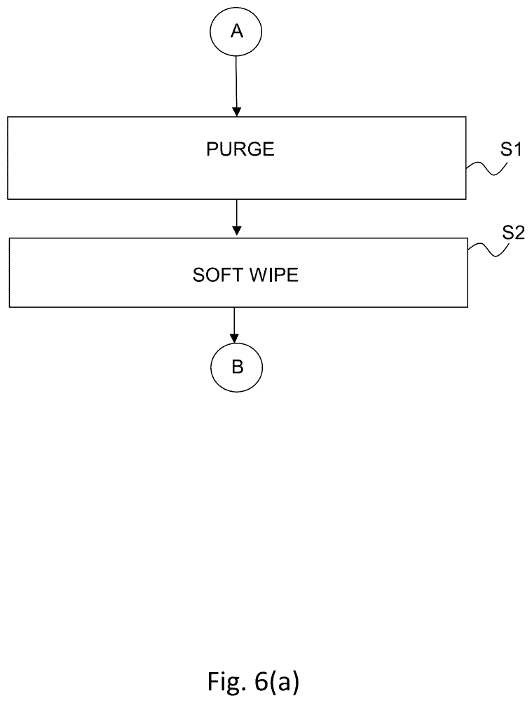

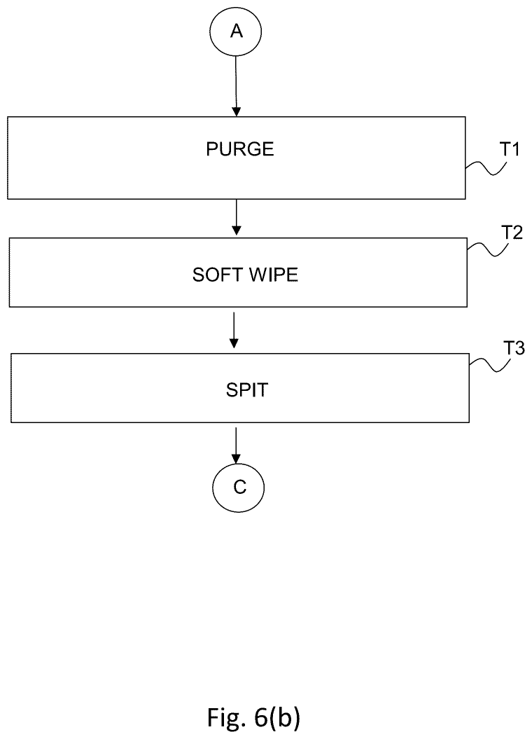

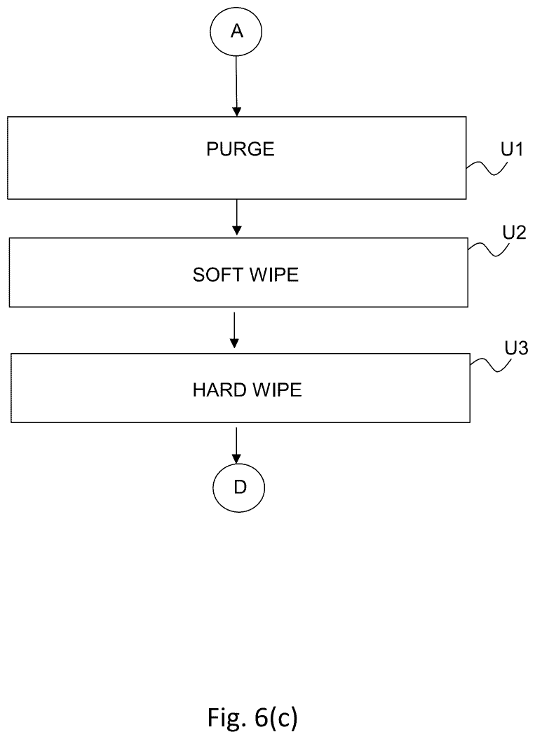

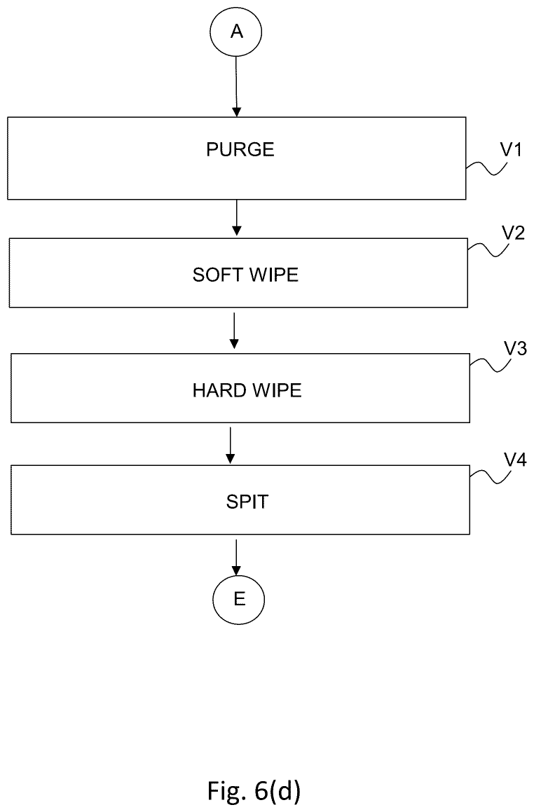

FIG. 6(a) is a flow diagram of a first embodiment of the method according to the present invention.

The method starts in a start point A which leads to a first step S1.

In the first step S1 the plurality of ink nozzles is purged at least once.

In the second step S2 the soft wipe is performed over the nozzle surface (or plate) with a first contact pressure close to zero but preferably of less than 0.5 kPa such that the first wipe barely touches the nozzle surface (or plate), with a wet tissue comprising a wetting liquid, with vacuum pressure provided by the air pressure supply unit.

The method ends in an end point B.

FIG. 6(b) is a flow diagram of a second embodiment of the method according to the present invention.

The method starts in a start point A which leads to a first step T1 which equals the first step S1 in FIG. 6(a). A second step T2 equals the second step S2 in FIG. 6(a).

The second step T2 is followed by a third step T3.

In the third step T3 the wetting liquid residing in the plurality of ink nozzles after the second wipe is spit out before commencing printing.

The method ends in an end point C.

FIG. 6(c) is a flow diagram of a third embodiment of the method according to the present invention.

The method starts in a start point A which leads to a first step U1 which equals the first step S1 in FIG. 6(a). A second step U2 equals the second step S2 in FIG. 6(a).

The second step U2 is followed by a third step U3.

In the third step U3 a hard wipe is performed after the first wipe. The hard wipe is a second wipe with the wet tissue comprising a wetting liquid, with a second contact pressure being higher than the first contact pressure in a range from 40 to 100 kPa and with a vacuum pressure provided by the air pressure supply unit.

The method ends in an end point D.

FIG. 6(d) is a flow diagram of a fourth embodiment of the method according to the present invention.

The method starts in a start point A which leads to a first step V1 which equals the first step S1 in FIG. 6(a). A second step V2 equals the second step S2 in FIG. 6(a). A third step V3 equals the third step U3 in FIG. 6(c).

The third step V3 is followed by a fourth step V4.

In the fourth step V4 the wetting liquid residing in the plurality of ink nozzles after the second wipe is spit out before commencing printing.

The method ends in an end point E.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. A method for maintenance of at least one print head of an inkjet printer, the at least one print head comprising an inlet to an ink chamber leading to a plurality of ink nozzles positioned in a nozzle surface and suitable for jetting ink, the inkjet printer comprising at least one air pressure supply unit, wherein the method comprises the steps of:
a) purging the plurality of ink nozzles at least once by providing a positive pressure on the ink chamber by means of the at least one air pressure supply unit; and
b) after purging the plurality of ink nozzles, performing a first wipe over the nozzle surface with a first contact pressure of close to 0 kPa such that the first wipe barely touches the nozzle surface,
wherein the first wipe is performed with a wet tissue comprising a wetting liquid and with a vacuum pressure provided by the at least one air pressure supply unit.

2. The method according to claim 1, wherein the method comprises the step of:
c) performing a second wipe after the first wipe,
wherein the second wipe is performed with the wet tissue comprising the wetting liquid, with a second contact pressure being higher than the first contact pressure in a range from 40 to 100 kPa and with the vacuum pressure provided by the at least one air pressure supply unit.

3. The method according to claim 1, wherein the method comprises the step of:
d) spitting out the wetting liquid residing in the plurality of ink nozzles after the first wipe before commencing printing.

4. The method according to claim 1, wherein the step of performing the first wipe comprises the step of positioning the wet tissue near the nozzle surface so that the wet tissue barely touches the nozzle surface.

5. The method according to claim 1, wherein the step of performing the first wipe comprises the step of pushing side rollers against bars of the nozzle surface.

6. The method according to claim 2, wherein the step of performing the second wipe comprises the step of applying the second contact pressure by means of springs which load bias a roller which presses the tissue to the nozzle surface in order to ensure a constant contact pressure.

7. The method according to claim 1, wherein the step of performing the first wipe comprises a removal of ink residue residing in the plurality of ink nozzles and a push of the wetting liquid into the plurality of nozzles.

8. The method according to claim 2, wherein the step of performing the second wipe comprises a removal of wetting liquid from the plurality of ink nozzles during the second wipe.

9. A digital inkjet printer for printing images on an image receiving medium on a printing surface, the digital inkjet printer comprising:
a print controller;
at least one print head with a nozzle surface with ink nozzles for ejecting marking material on the image receiving medium;
a wiper for cleaning the nozzle surface with the ink nozzles; and
a maintenance tray for receiving marking material spit from at least part of the ink nozzles,
wherein the print controller is configured to control the steps of the method according to claim 1.

10. A software product comprising program code on a non-transitory machine readable medium, which program code, when loaded into a print controller of a digital inkjet printer for printing images on an image receiving medium on a printing surface and having at least one print head, causes the print controller to control the at least one print head in accordance with the method as claimed in claim 1,
wherein the at least one print head comprises a nozzle surface with ink nozzles for ejecting marking material on the image receiving medium, a wiper for cleaning the nozzle surface with the ink nozzles and a maintenance tray for receiving marking material spit from at least part of the ink nozzles.
